(19) United States
(12) Patent Application Publication
(10) Pub. No.: US 2015/0193830 A1
(43) Pub. Date: Jul. 9, 2015

(54) SYSTEMS AND METHODS FOR OPTIMIZING MARKETING DECISIONS BASED ON VISITOR PROFITABILITY

(71) Applicant: III HOLDINGS 1, LLC, WILMINGTON, DE (US)

(72) Inventors: Jill Zucker, New York, NY (US); Tamar R. Shapiro, New York, NY (US)

(21) Appl. No.: 14/666,149

(22) Filed: Mar. 23, 2015

Related U.S. Application Data
(63) Continuation of application No. 13/353,532, filed on Jan. 19, 2012.
Application No. 13/353,532 is a division of application No. 12/692,171, filed on Jan. 22, 2010.

(51) Int. Cl. G06Q 30/02

(52) U.S. Cl. CPC G06Q 30/0273; G06Q 30/0255; G06Q 30/0269

(57) ABSTRACT

Marketing is facilitated based on a profitability prediction. A merchant optimizes offers to a website visitor based on predicted profit for potentially offered items. The profitability predication can be deployed to determine incentives to marketing affiliates, and to determine bids for search terms when the merchant uses a paid search bid manager. Information specific to a site visitor is used to predict a profitability metric for specific items that can be offered to that visitor.

### CROSS-REFERENCE TO RELATED APPLICATIONS

This application is a divisional of, and claims priority to, U.S. Ser. No. 12/692,171 filed Jan. 22, 2010 and entitled “SYSTEMS AND METHODS FOR OPTIMIZING MARKETING DECISIONS BASED ON VISITOR PROFITABILITY,” which is hereby incorporated by reference in its entirety.

### BACKGROUND OF THE INVENTION

1. Field of the Invention

The present invention generally relates to methods, systems, and computer program products for facilitating marketing decisions based on potential profit (also referred to herein as “profitability”) associated with a visitor (potential customer).

2. Related Art

Internet marketing is a common form of promotion for products and services. Many businesses use different types of internet marketing techniques such as e-mail marketing, website marketing, product recommendation systems, search engine marketing and so on. One of the main advantages of internet marketing is the ability to optimize marketing strategies in real-time according to business' objectives. Merchants typically utilize services of multiple partners, for example, a site content manager, a paid search bid manager, and/or a marketing affiliate, for internet marketing. A site content manager or a marketing affiliate optimizes presentation of product offers to visitors to a merchant's website or marketing affiliate's website, respectively. Furthermore, a paid search bid manager optimizes bidding strategy during an advertised auction hosted by paid search based search engines.

A widely utilized internet marketing optimization technique is based upon conversion rates (percentage of visitors who take a desired action) for products/services. While such optimization techniques may lead to promotion of products/services with high conversion rates, particular products/services may have a high conversion rate, but not necessarily be most profitable for a particular business. Some presently utilized techniques also incorporate concepts of product-level or geographical-level profitability while optimizing the internet marketing decisions. However, such techniques may present offers to customers that are not always relevant to the customers, resulting in lower conversion rates.

Given the foregoing, what is needed is a method, system and computer program product for optimizing internet marketing decisions more effectively.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

Consistent with the principles of the present invention as embodied and broadly described herein, the present invention meets the above-mentioned needs by providing methods, systems and computer program products for optimizing marketing decisions based on profitability.

In general, the various “embodiments” described in this patent document present various arrangements and methods in which profitability-based decisions can be used in place of other types of decisions in various marketing situations.

For example, according to one embodiment of the present invention, profitability-based decisions are used either alone or in combination with other factors (e.g. likelihood of response) to determine an order of presentation by a merchant of various “offers” on a web page display of offers.

According to another embodiment, when a merchant is in a marketing arrangement with a marketing “affiliate”, a profitability-based decision is used to determine how much “incentive” or “bounty” should be paid to the marketing affiliate for particular offers that the marketing affiliate makes to potential customers.

According to another embodiment, profitability-based decision making is utilized to determine how much to “bid” to a search engine provider for various “key words” or “search terms” that may be used in a potential customer search rather than simply always bidding a fixed amount for such key words or search terms or basing the amount on other factors.

One embodiment discloses a method for facilitating marketing optimization by a marketing partner. The method comprises receiving at a server, from a marketing partner, visitor information characterizing a visitor. A profitability metric for the visitor is estimated with respect to a product based, at least in part, on the visitor information. Optionally, an expected incentive value for the product is determined based, at least in part, on the profitability metric. At least one of the expected incentive value and the profitability metric are then provided to the marketing partner.

Another embodiment of the invention describes a method for optimizing presentation of one or more product offers of a merchant. The method comprises receiving, at a server, a trigger from a visitor for product offers corresponding to a plurality of products. Following the trigger, one or more profitability metrics for the visitor corresponding to the plurality of products are determined and product offers corresponding one or more products are presented to the visitor based, at least in part, upon the profitability metrics.

Yet another embodiment of the invention describes a method for optimizing bid amounts in a paid search auction. The method comprises receiving, at a server, a trigger from a paid search auction host for bidding on search keywords used by a visitor corresponding to one or more products of a merchant. Following the trigger, profitability metrics of the visitor corresponding to the one or more products of the merchant are determined and bids on the search keywords are optimized based, at least in part, on the profitability metrics.

Other embodiments of the invention describe systems for facilitating marketing optimization by a marketing partner. These system embodiments may include a network interface, at least one processor; and a memory in communication with the at least one processor. The memory is configured to store a plurality of processing instructions for directing the at least one processor to cause the system to receive visitor information of a visitor from the marketing partner. The processing instructions additionally direct the system to estimate a profitability metric of the visitor with respect to a product based, at least in part, on the visitor information and optionally determine expected incentive value for the product based, at least in part, on the profitability metric. The memory then directs the at least one processor to provide at least one of the expected incentive value and the profitability metric to the marketing partner.

Another embodiment of the invention describes a computer program product for facilitating marketing optimization by a marketing partner. The computer program product comprises a computer usable medium having control logic (computer-readable code) stored therein. The control logic, if executed by a computer system, causes the computer system to carry out functions as described below. According to this computer program product embodiment of the invention, the control logic comprises a first, a second, a third and a fourth computer readable code. The first computer readable code causes the computer system to receive visitor information of a visitor from the marketing partner. The second computer readable code causes the computer system to estimate a profitability metric of the visitor with respect to a product based, at least in part, on the visitor information. The third computer readable code causes the computer system to optionally determine expected incentive value for the product based, at least in part, on the profitability metric. Finally, the fourth computer readable code causes the computer system to provide at least one of the expected incentive value and the profitability metric to the marketing partner.

Another computer program product embodiment of the invention describes a computer program product for optimizing presentation of one or more product offers of a merchant. The computer program product comprises a computer usable medium having control logic (computer-readable code) stored therein. The control logic, if executed by a computer system, causes the computer system to carry out functions as described below. According to this computer program product embodiment of the invention, the control logic comprises a first, a second, and a third computer readable code. The first computer readable code causes the computer system to receive a trigger from a visitor, at a server, for product offers corresponding to a plurality of products. The second computer readable code causes the computer system to determine profitability metrics of the visitor corresponding to the plurality of products. Finally, the third computer readable code causes the computer system to present one or more product offers to the visitor based, at least in part, upon the profitability metrics.

Another computer program product embodiment of the invention describes a computer program product for optimizing bid amounts in a paid search auction. The computer program product comprises a computer usable medium having control logic (computer-readable code) stored therein. The control logic, if executed by a computer system, causes the computer system to carry out functions as described below. According to this computer program product embodiment of the invention, the control logic comprises a first, a second, and a third computer readable code. The first computer readable code causes the computer to receive a trigger from a paid search auction host, at a server, for bidding on search keywords used by a visitor, corresponding to one or more products of a merchant. The second computer readable code causes the computer to determine profitability metrics for the visitor with respect to the one or more products. Finally, the third computer readable code causes the computer to optimize bids on the search keywords based, at least in part, on the profitability metrics.

Various embodiments of the present invention provide systems, methods and computer program products for optimizing marketing decisions based on visitor profitability. The various embodiments may also include performing one or more of the aforementioned functions independently and in any order, as per the need.

Further features and advantages of the present invention as well as the structure and operation of various embodiments of the present invention are described in detail below with reference to the accompanying drawings.

### BRIEF DESCRIPTION OF THE DRAWINGS

Features and advantages of the present invention will become more apparent from the detailed description set forth below when taken in conjunction with the drawings, in which like reference numbers indicate identical or functionally similar elements. Additionally, the left-most digit of a reference number identifies the drawing in which the reference number first appears. The drawings, which are incorporated in and constitute part of the specification, illustrate embodiments of the invention and, together with the general description given above and the detailed descriptions of embodiments given below, serve to explain the principles of the present invention. In the drawings:

FIG. 1 is a schematic diagram showing a profitability-based marketing system deployed by a merchant according to the invention;

FIG. 2 is a schematic diagram showing a profitability-based marketing system deployed by a merchant utilizing the services of a marketing affiliate according to the invention;

FIGS. 3 and 4 illustrate how credit card offers can be presented to visitor 105 by merchant 104 and marketing affiliate 202 utilizing profitability-based marketing system 102;

FIG. 5 illustrates an exemplary embodiment in which merchant 104 employs a site content manager 502 for optimizing listing of credit card offers on merchant 104's website 112;

FIG. 6 illustrates the computation of a profitability metric for each of a plurality of credit card offers that may be presented to visitor 105;

FIG. 7 illustrates a presentation of credit card offers to visitor 105 based on the profitability metric calculations illustrated in FIG. 6;

FIG. 8 illustrates an exemplary arrangement in which merchant 104 employs a paid search bid manager 802 to bid for keywords in an advertisement auction;

FIG. 9 illustrates a profitability calculation used to determine bids for search terms when a merchant utilizes a search bid manager 802;

FIG. 10 is a flowchart illustrating one example process for facilitating marketing optimization by a marketing partner, according to various embodiments of the invention;

FIG. 11 is a flowchart illustrating one example process for listing product offers to a visitor, according to various embodiments of the invention;

FIG. 12 is a flowchart illustrating one example process for optimizing paid search bidding strategy, according to one embodiment of the invention; and

FIG. 13 is a block diagram of an exemplary computer system for implementing system 102 shown in FIG. 1 and the various processes illustrated in the flowcharts of FIGS. 10, 11 and 12.

### DETAILED DESCRIPTION OF THE INVENTION

### Overview

The invention will be better understood from the following descriptions of various “embodiments” of the invention. Thus, specific “embodiments” are views of the invention, but each does not itself represent the whole invention. In many cases individual elements from one particular embodiment may be substituted for different elements in another embodiment carrying out a similar or corresponding function.

The detailed description of exemplary embodiments of the invention herein makes reference to the accompanying drawings and figures, which show the exemplary embodiments by way of illustration only. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. Many alternative or additional functional relationships or physical connections may be present in a practical system.

The present invention is described herein with reference to system architecture, block diagrams and flowchart illustrations of methods, and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, causing it to become a special purpose machine or system, a special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Terminology

The term “merchant” shall mean any person, entity, distributor system, software and/or hardware that is a provider, broker and/or any other entity in the distribution chain of products or services. For example, a merchant may be an on-line merchant, a credit card issuer, a retail store, a travel agency, a service provider, and the like.

The term “marketing affiliate” and/or the plural form of the term shall mean an online sales promotion agent or an intermediary associated with the merchant. Further a marketing affiliate associated with a merchant may promote one or more products of the same merchant. Additionally, different marketing affiliates associated with a merchant may promote different products of the same merchant. Further a marketing affiliate may promote one or more products of different merchants.

The term “product” and/or the plural form of the term may be interchangeably used with the term “services”. Examples of products may include products such as credit cards, insurance policies, and the like. Further, examples of services may include services such as arranging for travel plans, booking of tickets, hotel reservations and the like.

The term “visitor” shall mean any person accessing or browsing a particular website on the internet. In the present invention, a “visitor” may be any person accessing or browsing the merchant's website, or the marketing affiliate's website or searching for the merchant's products on the internet using a search engine.

The term “customer” shall mean any person, entity, or the like that makes a purchase/transaction from the merchant, either directly or through an affiliate. Moreover in the present invention, a “customer” may also be broadly categorized as a “consumer” (a customer who makes primarily consumer-related purchases).

The term “commission” may be interchangeably used with the term “incentive”. Some examples of commission awarded to an affiliate by a merchant may include premiums, freebies, loyalty points, product warranties, discount on products of the merchant, or any combination thereof.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present invention are embodied in a profitability-based marketing system. The nomenclature “profitability-based marketing system” is only exemplary and used for descriptive purposes, and must not be construed to limit the scope of the present invention.

The present invention is now described in more detail herein in terms of the above disclosed exemplary embodiments of system, processes and computer program products. This is for convenience only and is not intended to limit the application of the present invention. In fact, after reading the following description, it will be apparent to one skilled in the relevant art(s) how to implement the following invention in alternative embodiments

Basic System

Various system embodiments described herein optimize marketing presentations and decisions based on potential profitability, either alone or in combination with other factors.

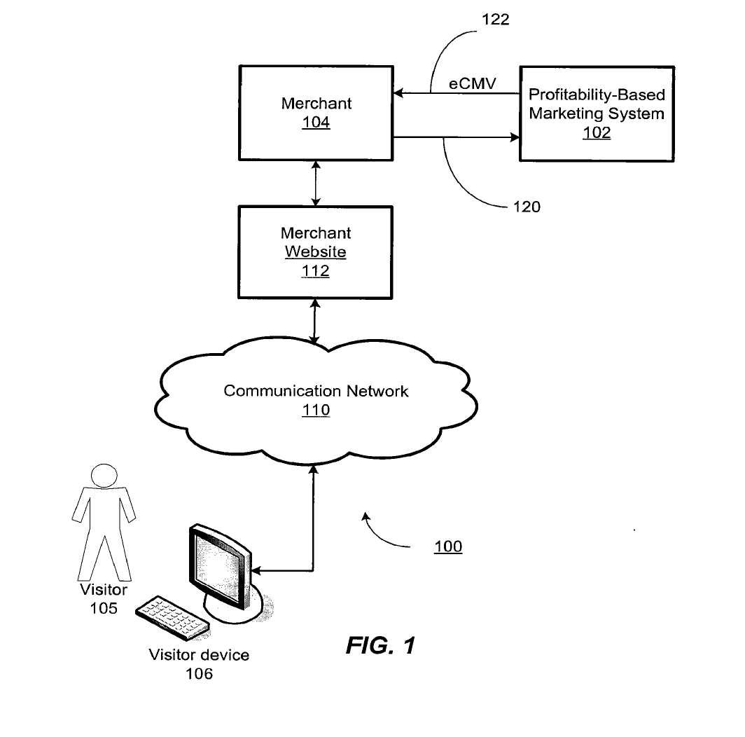

FIG. 1 is a schematic diagram showing a profitability-based marketing system deployed by a merchant according to the invention. Profitability-based marketing system 102 may be deployed as part of an exemplary environment 100. A visitor 105 may utilize a visitor device 106, such as a computer, hand-held PDA, internet supported cell phone, etc. to visit a website 112 of a merchant 104. At the merchant's website 112, the visitor may select from one or more offers to make a purchase. Merchant 104 utilizes profitability-based marketing system 102 to determine which offers are to be presented on website 112 to a particular visitor 105 based at least in part on a potential profitability of various potential offers based on knowledge that can be gleaned about visitor 105. Examples of communication network 110 include a wide area network (WAN), a local area network (LAN), an Ethernet, Internet, an Intranet, a cellular network, a satellite network, or any other suitable network for transmitting data. Communication network 110 may be implemented as a wired network, a wireless network or a combination thereof. Visitor(s) 105 use their visitor devices 106 to browse information on merchant website 112 about merchant 104's products/services. Examples of visitor device 106 include, but are not limited to, a desktop computer, a laptop, a palmtop, a pocket personal computer (PC), a mobile phone, a personal digital assistant (PDA) and the like. A web browser, for example, Microsoft's INTERNET EXPLORER™, NETSCAPE NAVIGATOR™, MOZILLA FIREFOX™, OPERA™, Google's CHROME™ and the like, may reside on visitor device 106 enabling visitor device 106 to receive and transmit data over communication network 110.

Merchant 104 deploys profitability-based marketing system 102 to assist with a determination of what offers to present to a visitor 105. It may not make sense to display the same exact set of offers to all visitors or to present offers in a random fashion to each visitor. For a particular visitor 105 to merchant website 112, certain offers may have a greater profitability metric than other offers. The profitability metric for a given visitor 105 with respect to an offer A might be different from the profitability metric for a different visitor 105 with respect to the same offer A. Also, the profitability metric for a particular visitor 105 may be different for offer A than it is for offer B. Each visitor is unique. To illustrate the concept further, reference will be made to offers of credit card products. Although profitability-based marketing system 102 is described herein in terms of credit card products, it will be readily apparent to one skilled in the art that a similar profitability-based marketing system may be deployed for other types of products such as, but without limitation, loans, insurance plans, travel packages, retail goods and the like.

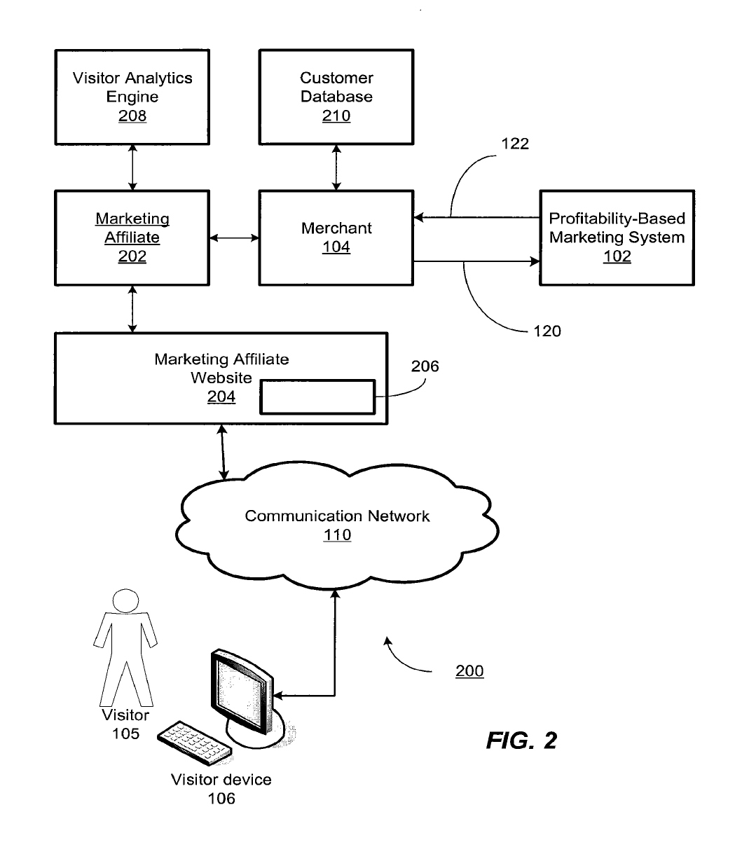

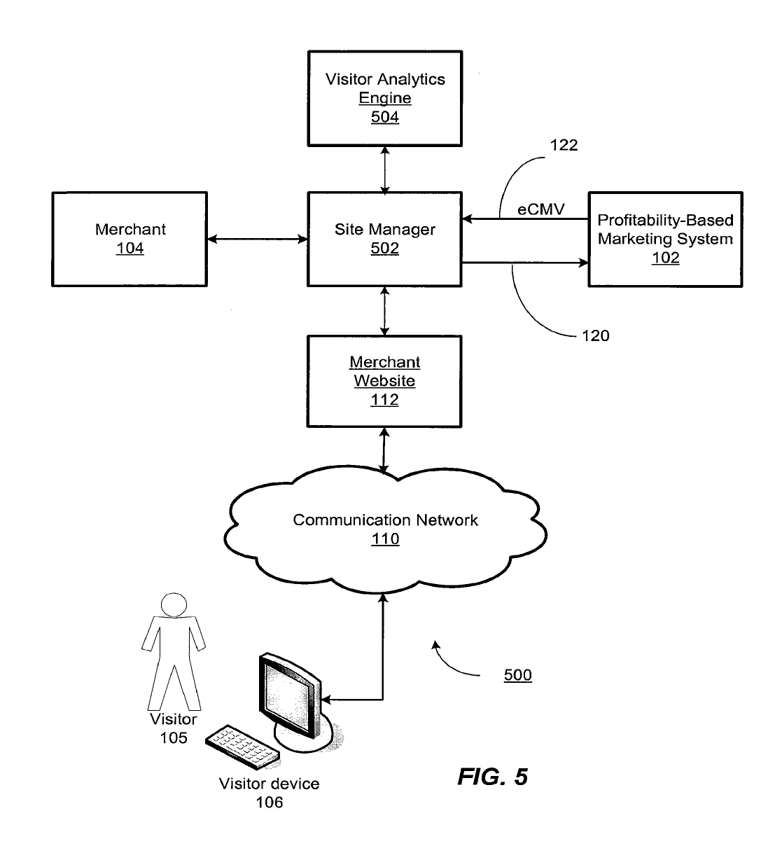

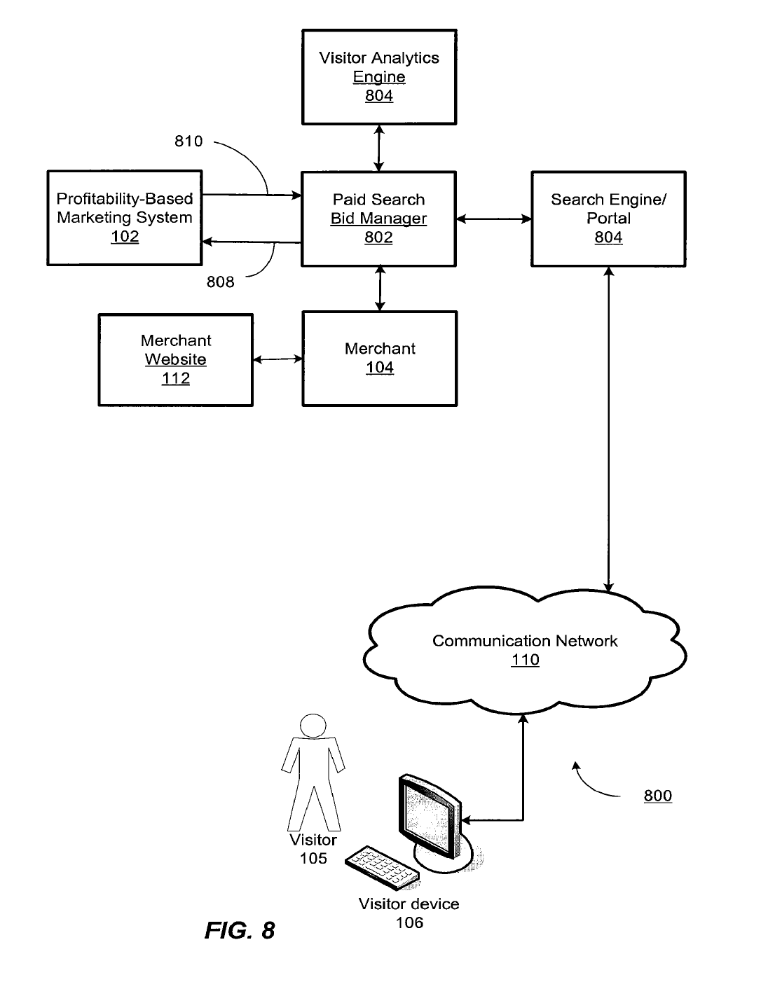

Profitability-based marketing system 102 enables merchant 104, optionally working in conjunction with a marketing affiliate to optimize marketing decisions based upon visitor-level profitability. For example, merchant may work directly with a marketing affiliate 202 as shown in FIG. 2 which attracts visitors 105 to the market affiliate's website 204. Merchant may work with a site manager such as site manager 502, shown in FIG. 5, to manage a website visited by visitors 105. Merchant 104 may work with a paid search bid manager such as paid search bid manager 802 shown in FIG. 8 to determine how much to bid for various search terms when a visitor 105 conducts a search using a search engine. A person skilled in the art will appreciate that these various deployment arrangements are presented for exemplary purpose only and that other deployment scenarios are possible without deviating from the spirit and scope of the present invention.

Merchant 104, either directly or with the aid of a marketing partner, gathers visitor information for visitor(s) 105, which include, without limitation, the visitor's personal information and the visitor's online behavior information. The visitor's personal information may include a name, an address, current geographical location, gender, age, other demographic information, e-mail address, social security number, and the like. For example, merchant 104 or marketing affiliate 202 may receive the personal information in an application for credit card form filled by visitor 105. The visitor's online behavior information may include, but is not necessarily limited to, Internet Protocol (IP) address, unique cookie identification data, web browsing patterns, online purchase history etc. In various embodiments, the visitor's personal information may be entered by a visitor 105 via visitor device 106 while creating a profile on merchant website 112. Merchant 104 may obtain a visitor's 105 online behavior information using a visitor analytics engine, such visitor analytics engine 208 shown in FIG. 2, visitor analytics engine 504 shown in FIG. 5, and visitor analytics engine 804 shown in FIG. 8. Alternatively, the visitor analytics engine may be implemented by a third party service provider, for example, Google Analytics, Urchin Software from Google Inc., Yahoo!Web Analytics, Omniture's Site Catalyst.

However the visitor information is obtained, the profitability-based marketing system 102 is provided with the visitor information. Visitor information is provided via a communication path 120 from merchant 104. However, the visitor information could be provided by a marketing partner, by a visitor analytics engine or a third party service. Profitability-based marketing system 102 then estimates a profitability metric for visitor 105 with respect to a set of potentially offered product or service based, at least in part, on the visitor information and provides a profitability metric for each such product or service to merchant 104 via a communication path 122. Using the profitability metric for each product or service, merchant 104 can decide what products/services to offer and how offers should be presented to visitor 105 on merchant website 112. For example, products having a high profitability metric may be displayed higher in a list than those having a lower profitability metric.

Profitability-based marketing system 102 may also use financial data for estimating the profitability metric. Profitability-based marketing system 102 may also use additional information, such as, lifetime of the product, operating cost of the product etc., while estimating the profitability metric. Profitability-based marketing system may retrieve the financial data of visitor 105, based, at least in part, upon the visitor information received from the visitor or from a marketing partner such as marketing affiliate 202. Examples of the visitor's financial data are income range, investment portfolio, spending patterns, share of wallet, household income, credit history, credit rating (for example, FICO rating), number of credit cards held by the visitor, number of add-on cards, number of revolving accounts, revolving amount and the like. In various embodiments, profitability-based marketing system 102 may retrieve the financial data. This data could be data at the individual level or aggregated data, such as, for example, based on zipcode, or based on online characteristics. The data can be obtained from various sources, such as, without limitation, banks, credit bureaus, financial institutions, and/or dedicated companies/agencies (for example, “comScore Networks Inc.”) that may provide such information. For extraction of the financial data of the visitor(s) 105, profitability-based marketing system 102 extracts at least one or more of visitor 105's personally identifiable information, such as, the e-mail address, the SSN number and the like, from the personal information and further uses that personally identifiable information to query the different sources. In various other embodiments, profitability-based marketing system 102 may receive the complete visitor information including the financial data of the visitor 105 from marketing affiliate 202. In some embodiments, profitability-based marketing system 102 may retrieve the financial data of visitor(s) 105 from a customer database deployed by merchant 104 or marketing affiliate 202. The customer database may maintain a record of the financial data for all customers, which is retrievable by using a unique identifier associated with each of the customer. The unique identifier may be the personally identifiable information, and/or a username created by a visitor during a registration process and the like.

Calculation of Profitability

In an exemplary implementation, the profitability metric is defined to be an “electronic Card Member Value” (eCMV) and is estimated based on the following equation:

eCMV=[Predicted customer-level 18 month(revenue minus expense)]projected to a lifetime value using functional forms

Models used to predict 18 month “revenue minus expense” (RME) use a variety of independent variables, including credit attributes (such as number of inquiries, credit utilization, count of transacting cards) as well as some non-credit attributes (including connection type, online response channel, number supplemental cards applied for at acquisition). The dependent variable is the customer-level data regarding actual revenues and expenses over the prior 18 months, to the extent available. Functional forms are used to project the predicted customer-level 18 month RME into a lifetime value using standard finance assumptions (such as hurdle rate and run-off rate) to calculate a terminal value.

Profitability-based marketing system 102 predicts customer-level RME. The customer-level RME is a measure of profit from visitor 105 for a particular product, and is calculated by taking into account the risks that may be associated with visitor 105, for example, delayed payment, default on credit due, and the like that increase expense. A higher RME for visitor 105 implies a lower risk involved for merchant 104 and vice-versa. In an embodiment, profitability-based marketing system 102 may use multiple variables to compute the profitability metric.

In some embodiments, profitability-based marketing system 102 may directly use the visitor information as the variables. Alternatively, in some embodiments, profitability-based marketing system 102 may partly derive the variables from the visitor information. In various embodiments, the customer-level “risk adjusted margin” is calculated for a pre-defined period of time. In one exemplary implementation, the pre-defined period equals 18 months. However, a person skilled in the art will appreciate that any other suitable period may be used for predicting the “risk adjusted margin” without deviating from the spirit and scope of the invention. Profitability-based marketing system 102 may then multiply the customer-level “risk adjusted margin” with one or more lifetime factors that may depend upon a particular product group. The product lifetime metrics are multiplicative factors for each product, indicative of the average lifetime of the product. Moreover, the product lifetime metrics may also be calculated as multiplicative factors for each product, indicative of the average value added to merchant 104 by each sale of that product.

In various embodiments, profitability-based marketing system 102 may further determine an incentive value to be paid to a marketing affiliate (such as, for example, market affiliate 202 shown in FIG. 2) based on a profitability metric determined for a particular visitor 105 for a particular product. For example, a higher incentive payment made be made to a marketing partner if a particular visitor/product results in a higher profitability metric. In an embodiment, merchant 104 may pay the incentive value as a commission to a marketing partner, in case of the purchase of the product by visitor 105. A person skilled in the art will appreciate that alternate ways of providing incentive, for example, revenue share, pay-per-click payment, pay-per-view payment, pay-per-action payment, product discounts etc., are also possible without deviating from the spirit and scope of the present invention.

For example, the incentive value may be a flat fee based on the profitability metric of the visitor. A merchant may be willing to pay a marketing affiliate $100 for acquisition of a visitor with a profitability metric within a given range, 20% more ($120) if the profitability metric is above the range, and 20% less ($80) if the profitability metric is below the range.

Profitability-based marketing system 102 provides the estimated profitability metric and/or the expected incentive value to marketing affiliate 202. Marketing affiliate 202 may use the profitability metric and/or the expected incentive value to optimize its marketing decisions. Various embodiments for optimization of marketing decisions by marketing affiliate 202 for different scenarios are described in conjunction with FIGS. 2-4.

Marketing Affiliate Embodiment

FIG. 2 is a schematic diagram showing an arrangement 200 of profitability-based marketing system deployed by a merchant utilizing the services of a marketing affiliate 202 according to the invention. In this arrangement visitor 105 visits a website 204 of marketing affiliate 202 rather than directly visiting a website of merchant 104. It is marketing affiliate 202 that displays various offers to visitor 105. For purposes of illustration, the credit card industry is used as an example. Marketing affiliate 202 presents one or more advertisements for credit cards offered by merchant 104 to visitor(s) 105 on marketing affiliate 202's website 204. Examples of various marketing affiliates in the credit industry include Creditcards.com, Credit-land, and NCS etc. Marketing affiliate 202 may optimize the presentation of credit card offers to visitor 105 based, at least in part, upon the profitability of individual visitors or a sub-set of visitors website 204.

When visitor 105 wishes to apply for a credit card or wishes to compare different credit card offers, visitor 105 accesses marketing affiliate 202's website 298 using a web browser residing on a visitor device 198 to look for various credit card offers. In some embodiments, visitor 105 may be required to enter a unique identifier or combination of identifiers (for example, a username, a customer ID, password and the like) in order to access marketing affiliate 202's website 204. Visitor 105 may browse through marketing affiliate 202's webtsite 204 to look for credit card offers to choose a particular credit card. Alternatively, marketing affiliate 202's website 204 may provide a link to a webpage presenting credit card offers and visitor 105 may follow the link in order to view the credit card offers. In additional embodiments, marketing affiliate website 204 may also present a search interface 206 to visitor 105 to enable visitor 105 to search for a desired credit card. Further, marketing affiliate 202 may obtain at least one of: 1) visitor information from a visitor analytics engine 208, and 2) visitor 105's profile stored in a customer database 210, once the visitor 105 accesses the webpage presenting the credit card offers, or submits a search request through the search interface. Customer database is shown as being affiliated with merchant 104, but it could be associated with marketing affiliate 202 as well.

Marketing affiliate 202 may identify one or more credit cards that may be relevant for visitor 105 based, at least in part, upon visitor 105's information, which may include visitor 105's preferences, income range etc. Marketing affiliate 202 sends the visitor information to profitability-based marketing system 102 either directly or via merchant 104 as indicated by arrow 120. Marketing affiliate 202 may also send information about the relevant credit cards to merchant 104. Profitability-based marketing system 102 then estimates the profitability metric, for example, eCMV, for visitor 105 with respect to the relevant credit cards. Profitability-based marketing system 102 also determines an incentive value, for example, a commission, with respect to the identified credit cards based, at least in part, upon the profitability metric. The commission is payable to marketing affiliate 202, by merchant 104, upon successful approval of a credit card that visitor 105 selects through marketing affiliate 202. Merchant 104 may pay more commission to marketing affiliate 202 for those visitors 105 who exhibit higher profitability metrics. Profitability-based marketing system 102 may implement a mathematical model to calculate the expected commission using the profitability metric. Profitability-based marketing system 102 may define a graded commission scheme with the grades corresponding to respective ranges of profitability metric values; for example, profitability-based marketing system 102 may provide $50 as commission if the profitability metric for a visitor is within $1500-$2000 and may pay $80 if the profitability metric for the visitor is within $2000-$3000. Profitability-based marketing system 102 passes its calculated values back to merchant 104 and marketing affiliate 202 as indicated by arrow 122.

Marketing affiliate 202 may also estimate the expected commission from historical commissions received for a plurality of visitors similar to visitor 105. The similar visitors may be identified as visitors who may have at least one or more of similar age, gender, other demographic information, geographical location, income range, preferences, online behavior information, browsing patterns etc. as of visitor 105.

Subsequently, marketing affiliate 202 may compute estimated earnings of the merchant based, at least in part, upon the expected commission value. In an exemplary implementation, the estimated earnings equal expected conversion rate for a particular credit card multiplied by the expected commission. Marketing affiliate 202 may then present the credit card offers to visitor 105 in a decreasing order of the expected earnings, which marketing affiliate 202 may receive as commission. In this case, the expected earnings are dependent of the profitability metric of visitor 105.

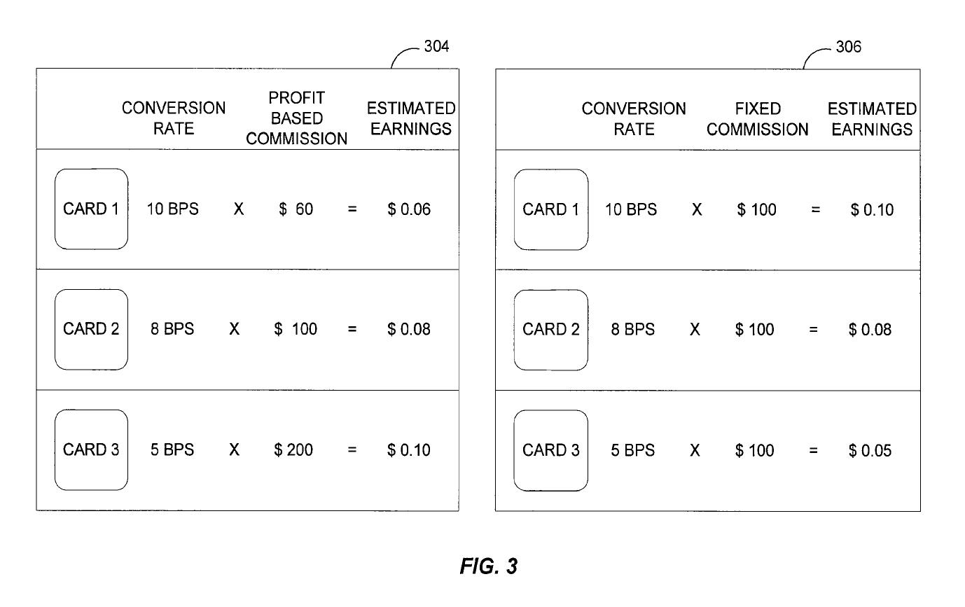

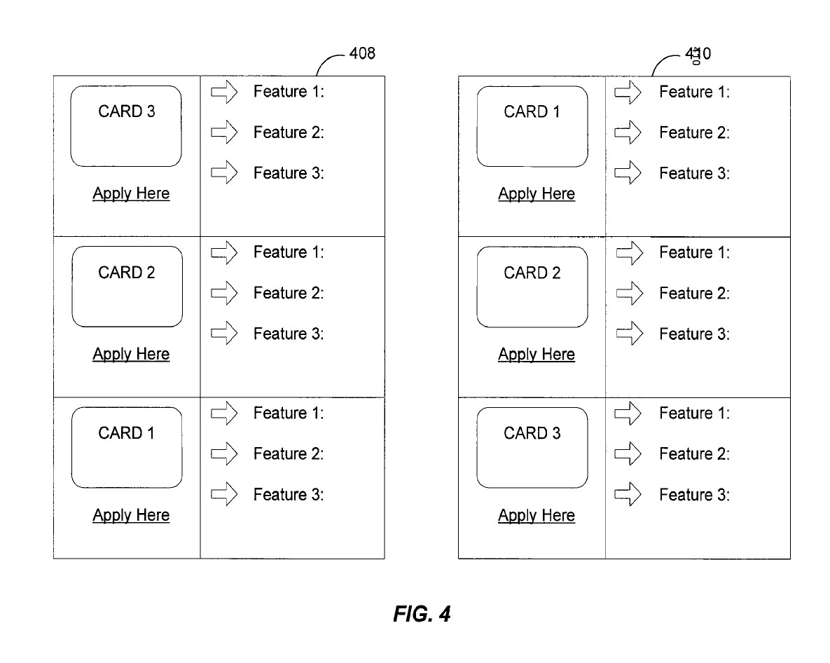

FIGS. 3 and 4 illustrate how credit card offers can be presented to visitor 105 by merchant 104 and marketing affiliate 202 utilizing PROFITABILITY-BASED MARKETING SYSTEM 102. In this example, consider offers for three credit cards—Card 1, Card 2 and Card 3—which are to be presented to visitor 105. Table 304 illustrates the estimated earnings based upon the profitability-based commission for visitor 105 corresponding to three different credit cards, according to one embodiment. As shown in Table 304, the profitability-based commission is highest for Card 3 indicating that visitor 105 would be most profitable to merchant 104 in case of selection of Card 3 as compared to other cards. Moreover, in case of approval of Card 3, marketing affiliate 202 may earn more than would be earned in the case of approval of another card, even though the expected conversion rate for Card 3 may be the lowest. For comparison, Table 306 of FIG. 3 shows the estimated earnings using a fixed commission scheme in which marketing affiliate 202 earnings depend only upon the conversion rate. Table 408 of FIG. 4 illustrates the listing order of offers for Cards 1-3 based on the profitability-based commission. As shown, in case of profitability-based commission, an offer for Card 3 is listed at the top followed by an offer for Card 2 and then an offer for Card 1. In contrast, according to the fixed commission scheme illustrated in Table 410, the offers are listed in the order Card 1, Card 2, Card 3. Thus, profitability-based marketing system 102 incentivizes marketing affiliate 102 to show offers that are more profitable to merchant 104 and in turn for marketing affiliate 102.

Merchant 104 may choose to markets its product, for example, credit cards, on its own merchant website, as shown in FIG. 1.

Site Content Manager Embodiment

FIG. 5 illustrates an exemplary embodiment in which merchant 104 employs a site content manager 502 for optimizing listing of credit card offers on merchant 104's website 112. A site content manager, for example, Omniture's Touch Clarity, optimizes presentation of a merchant's products and/or services to the visitors on the merchant's website 112. Again, for the ease of explanation the marketing of credit cards is used as an example. Site content manager 502 optimizes a presentation of credit card offers based, at least in part, upon a profitability calculation of particular card offers for an individual visitor 105. Site content manager 502 gathers the visitor information on access of merchant 104's website 112 for visitor 105. Visitor 105 may or may not be required to log in to enter merchant 104's website. Site content manager 502 may then obtain the visitor information from a visitor analytics engine 504, visitor 105's profile stored on a visitor database, or other data sources or combinations thereof. An example of a visitor's database is a database stored and maintained by the optimization vendor. Data can be updated in real time. Subsequently, site content manager 502 passes the visitor information to profitability-based marketing system 102, as indicated by arrow 122. Profitability-based marketing system 102 then estimates the profitability metric for visitor 105 with respect to one or more credit cards that may be relevant for visitor 105. Profitability-based marketing system 102 calculates eCMV as described in conjunction with FIG. 1, for visitor 105. Profitability-based marketing system 102 may then return the profitability metric to site content manager 502 as indicated by arrow 122.

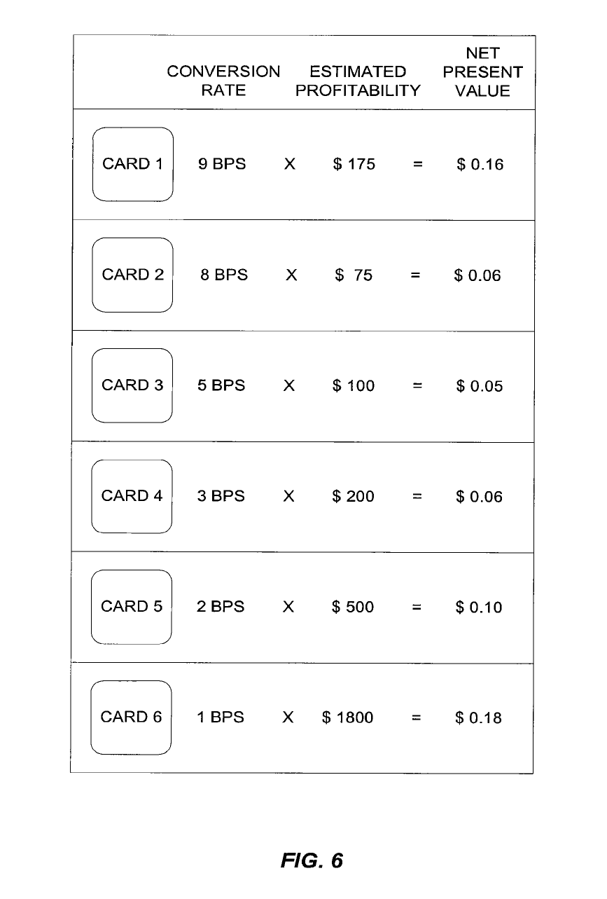

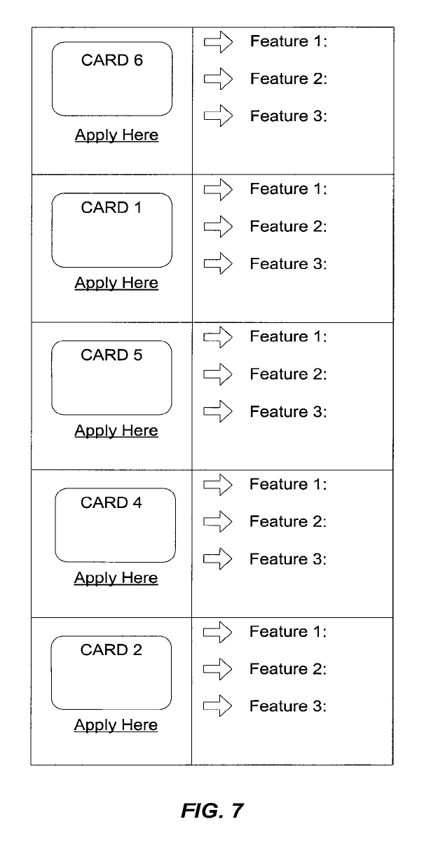

Alternatively, site content manager 502 may estimate the profitability metric for visitor 105 from the profitability metric estimated for a plurality of other visitors similar to visitor 105. The similar visitors may be identified as visitors who may have at least one or more of similar age, gender, other demographic information, geographical location, income range, preferences, online behavior information, browsing patterns etc. as of visitor 105. It will be appreciated that site content manager 502 may use any known techniques of statistical correlation to estimate profitability metrics of visitor 105 from the profitability metrics of the identified similar visitors. Site content manager 502 may then evaluates visitor 105's Net Present Value (NPV) for merchant 104 associated with the one or more credit cards based upon the profitability metric for visitor 105. In an exemplary implementation, for a particular credit card, the NPV is calculated as a product of expected conversion rates for the particular credit card and the profitability metric of visitor 105 for the particular credit card, as shown in FIG. 6 for one example case. Subsequently, site content manager 502 presents the one or more credit cards to visitor 105 in a decreasing order of the NPV, as illustrated in FIG. 6. In one exemplary implementation, only a pre-defined number, of offers are presented to visitor 105. In this exemplary case, total of five offers are presented to visitor 105. The pre-defined number may be decided by site content manager 502, or by merchant 104. It can be seen from FIG. 7 that Card 6 is presented at the top of the list, as the NPV of visitor 105 for Card 6 is the highest even though the expected conversion rate is the lowest. Thus, profitability-based marketing system 102 enables site content manager 502 to optimize content presentation on merchant 104's website to maximize earnings for merchant 104.

Search Bid Manager Embodiment

FIG. 8 illustrates an exemplary arrangement in which merchant 104 employs a paid search bid manager 802 to bid for keywords in an advertisement auction. A paid search based search engine may hosts the key word advertisement auction. Typically, bidding for search key words is carried out based on past experience, desire for business, etc. Using profitability-based marketing system 102, the bidding for search terms can be done based on a profitability calculation. When visitor 105 runs a search at a search engine portal 804 using keywords that are relevant to merchant 104, the paid search based search engine initiates the advertisement auction for one or more advertisement spots on a search engine results page. Bid optimization is optimally carried out in real time. As a practical matter, it is contemplated that bids would not get updated more than approximately once a day. The paid search based search engine contacts paid search bid manager 802. Subsequently, paid search bid manager 802 obtains the visitor information from a visitor analytics engine 804. The visitor analytics engine 804 may be deployed by paid search bid manager 402 or may be hosted by a third party, for example, Google Analytics, Urchin Software from Google Inc., Yahoo!Web Analytics, and Omniture's Site Catalyst etc.

In one embodiment, paid search bid manager 802 may then send the visitor information to profitability-based marketing system 102 as indicated by arrow 808. Paid search bid manager 802 may also send the one or more keywords entered by visitor 105. Subsequently, profitability-based marketing system 102 estimates eCMV (the profitability metric) of visitor 105, based upon the visitors information, for one or more sets of keywords. Each set of keywords may include one or more keyword that are relevant to merchant 104. For example, in the credit card industry, examples of relevant keywords include, but are not limited to, “credit cards”, “gold card”, “travel rewards” and the like. In some embodiments, profitability-based marketing system 102 may be required to retrieve additional visitor information from other data sources, such as, without limitation, banks, credit bureaus, third party service providers etc. Profitability-based marketing system 102 then sends the estimated profitability metric to paid search bid manager 402 as indicated by arrow 810.

Paid search bid manager 802 then calculates an expected value of visitor 105 to merchant 104, based upon the estimated profitability for each set of keywords. In an exemplary implementation, the expected value of visitor 105 equals a product of expected conversion rate of visitor 105 for each set of keywords and the profitability metric for that set of keyword.

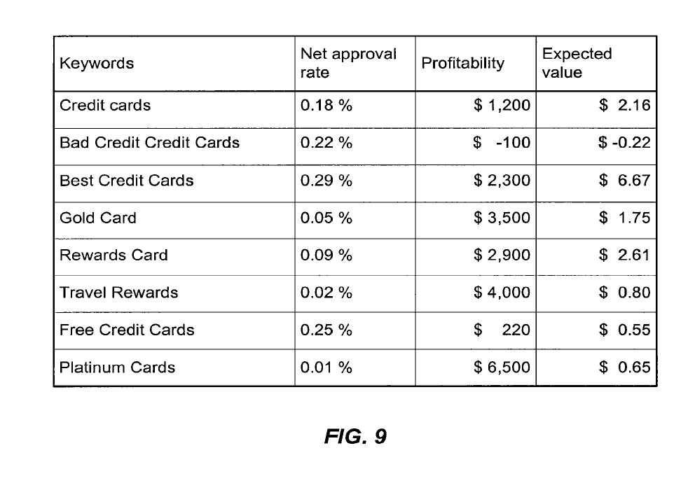

FIG. 9 shows an exemplary list of keywords and the associated net approval rate, profitability and the expected values. The profitability metric of visitor 105 for the keywords “platinum cards” is the highest at $6,500 whereas it is lowest for the keywords “bad credit credit cards” at −$100. On the other hand, the expected value of visitor 105 is the highest for the keywords “best credit cards” and is the lowest for the keywords “bad credit credit cards”. Paid search bid manager 802 uses the expected value of visitor 105 to optimize decision on the set of keywords, on which the bid is to be placed. Paid search bid manager 802 may then increase the bid amount if visitor 105 exhibits a higher expected value, and decrease the bid amount if visitor 105 exhibits a lower expected value. For example, (considering the exemplary case illustrated in FIG. 9) paid search bid manager may pay a premium on its bid for the keywords “best credit cards”. Paid search bid manager 802 may exclude keywords from the bidding process if paid search bid manager 802 determines that the expected values of visitor 105 corresponding to those keywords are unfavorable for bidding. For example, expected values may be determined as unfavorable if visitor 105 may bring little or no profit to merchant 104. For example, (considering the exemplary case illustrated in FIG. 9) paid search bid manager 802 may remove the keywords “bad credit cards” from the list of keywords. Alternatively or in addition, paid search bid manager 802 may also vary bid amounts for individual sets of keywords based upon the expected value of visitor 105, where the expected value depends upon the profitability metric of visitor 105. The examples described above are only some examples of how the paid search bid manager may optimize its bid decisions based upon visitor-level profitability and a person skilled in the art will recognize other ways of optimizing bid decisions based upon the visitor-level profitability.

Visitor Level Profitability Prediction Process

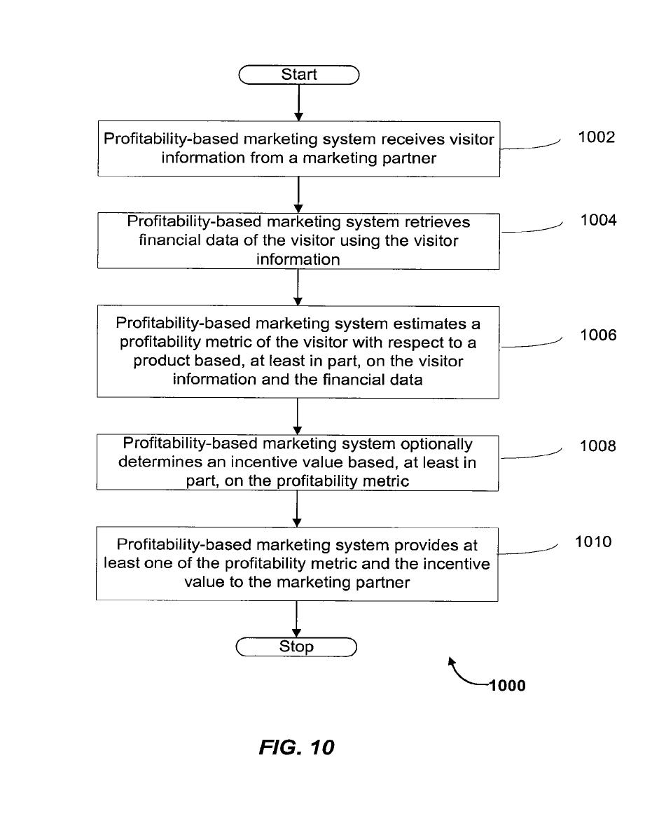

FIG. 10 is a flowchart illustrating a process 1000 for facilitating a third party to optimize marketing decisions using customer level profitability, according to one embodiment. In step 1002, profitability-based marketing system 102 receives, at a server (a suitable computer system 800 as shown in FIG. x can act as such a server), visitor information for a visitor, such as, for example visitor 105 shown in FIG. 1, from a third party. In one embodiment, profitability-based marketing system 102 receives the visitor information in an application form for a product, for example, a credit card, a loan, an insurance scheme and the like, via marketing affiliate 202. In other embodiments the visitor information may be otherwise obtained.

In step 1004, profitability-based marketing system 102 uses the visitor information to retrieve financial data of visitor 105 from various sources, such as, without limitation, banks, credit bureaus, financial institutions, and/or dedicated companies/agencies (for example, “comScore Networks Inc.”) that provide such information etc. or from the customer database(s) maintained by merchant 104 for predicting profitability metrics of visitor 105.

In step 1006, profitability-based marketing system 102 estimates a profitability metric for visitor 105 with respect to one or more products of merchant 104 based, at least in part, on the financial data of visitor 105. In some embodiments, Profitability-based marketing system 102 may also consider the visitor information to estimate the profitability metric for visitor 105. In one embodiment, Profitability-based marketing system 102 estimates the eCMV for visitor 105 as described in conjunction with FIG. 1.

In step 1008, profitability-based marketing system 102 optionally determines expected incentive value for marketing affiliate 202 with respect to the one ore more product based upon the estimated profitability metric. The incentive value indicates a remunerative incentive, for example, commission, that merchant 104 pays to a marketing partner when visitor 105 purchases a particular product as promoted or marketed by that marketing partner.

In step 1010, profitability-based marketing system 102 provides the estimated profitability metric or expected incentive value or both to marketing affiliate 202.

Site Content Optimization Process

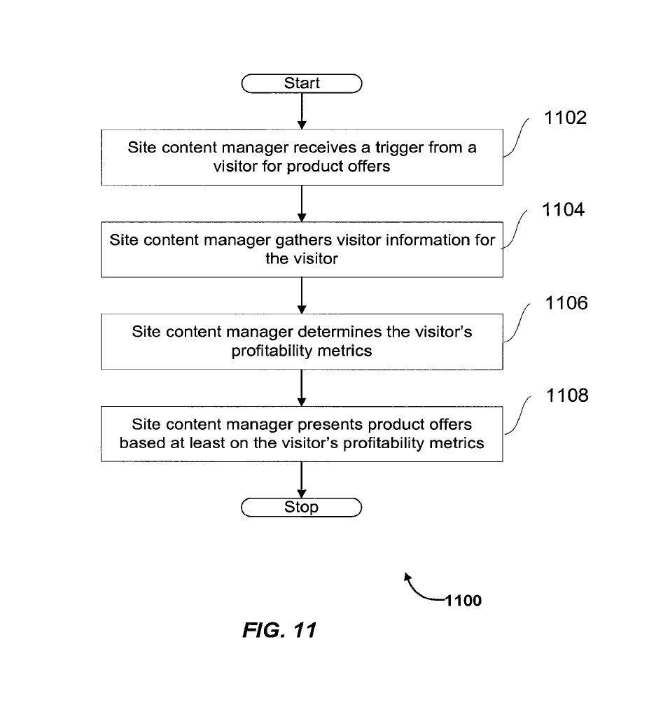

FIG. 11 is a flowchart illustrating an exemplary process 1100 for optimizing presentation of one or more product offers of merchant 104 on merchant website 112, according to one embodiment. In step 1102, site content manager 502 receives a trigger for displaying product offers of merchant 104. In one embodiment, the trigger may be a page access request by visitor 105 using a Universal Resource Locator (URL) of merchant 104 or a search request by visitor 105 for one or more product offers corresponding to a product category.

In step 1104, site content manager 502 gathers visitor information for visitor 105 from the visitor analytics engine.

In step 1106, site content manager 502 determines a profitability metric for visitor 105 with respect to each product of one or more products to be offered to visitor 105 based, at least in part, on the visitor information. In one embodiment, site content manager 502 sends the visitor information to profitability-based marketing system 102 and receives the profitability metric from profitability-based marketing system 102 in response. In various embodiments, site content manager 502 identifies a plurality of visitors similar to visitor 105 using the visitor information of visitor 105 and other past visitors to merchant 104's website. Thereafter, site content manager 502 estimates the profitability metric for visitor 105 using the profitability metric for the plurality of similar visitors.

In step 1108, site content manager 502 presents the product offers to visitor 105 based, at least on, the estimated profitability metric. In one exemplary implementation, site content manager 502 considers the conversion rates of the products in addition to the profitability metrics of the visitors to calculate the net present values of visitor 105 corresponding to the products of merchant 104. Site content manager 502 then presents the product offers in decreasing order of the net present values.

In some embodiments, site content manager 502 determines conversion rates for the products offered by merchant 104. In other embodiments, site content manager 502 retrieves the conversion rates from the visitor analytics engine or from merchant 104.

Paid Search Bid Optimization Process

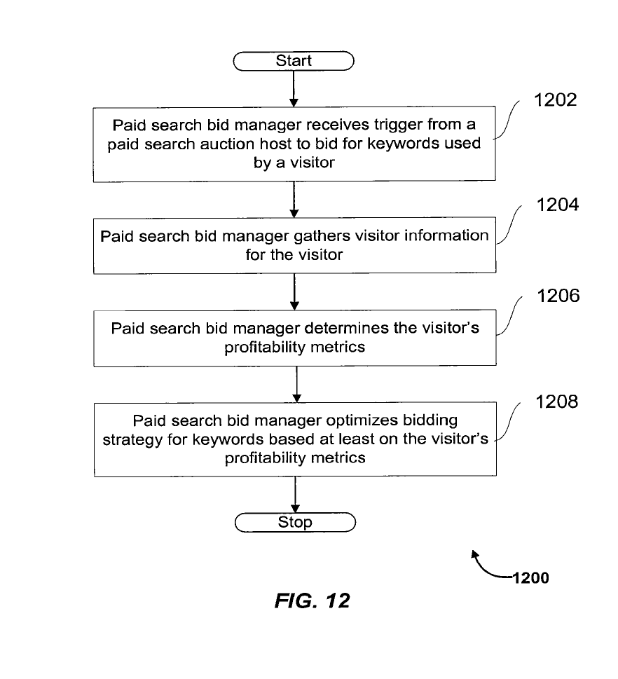

FIG. 12 is a flowchart illustrating an exemplary process 1200 for optimizing bidding on keywords and ad groups based on two-stage profitability modeling, according to one embodiment.

In step 1202, paid search bid manager 802 receives a trigger from the auction host (a paid search based search engine in this case), for bidding on keywords used in the keyword search by visitor 105. In one embodiment, the auction host sends the trigger to paid search bid manager 802 when visitor 105 executes a keyword search using one or more keywords specified by paid search bid manager 802.

In step 1204, paid search bid manager 802 gathers visitor information for visitor 105 from the visitor analytics engine.

In step 1206, paid search bid manager 802 determines a profitability metric for visitor 105 with respect to each product of one or more products to be offered to visitor 105 based, at least in part, on the visitor information. In one embodiment, paid search bid manager 802 sends the visitor information to profitability-based marketing system 102 and receives the profitability metric from profitability-based marketing system 102 in response. In various embodiments, paid search bid manager 802 identifies a plurality of visitors similar to visitor 105 using the visitor information of visitor 105 and other past visitors to merchant 104's website. Thereafter, paid search bid manager 402 estimates the profitability metric for visitor 105 using the profitability metric for the plurality of similar visitors.

In step 1208, paid search bid manager 802 optimizes the bidding strategy based, at least on, the profitability metrics of visitor 105. In one exemplary implementation, paid search bid manager 802 considers the conversion rates of the products in addition to the profitability metrics of the visitor to calculate the expected values of visitor 105 corresponding to the keywords specified by merchant 104. Paid search bid manager 802 then optimizes the bidding strategy for keywords used by visitor 105, based on the expected values of visitor 105.

Alternative Implementations

The present invention explained with reference to system embodiments such as system 100, system 500 and system 800, process embodiments including process 1000, process 1100 and process 1200, or any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part of the present invention. Rather, the operations are machine operations. Useful machines for performing the operations in the present invention may include general-purpose digital computers or similar devices.

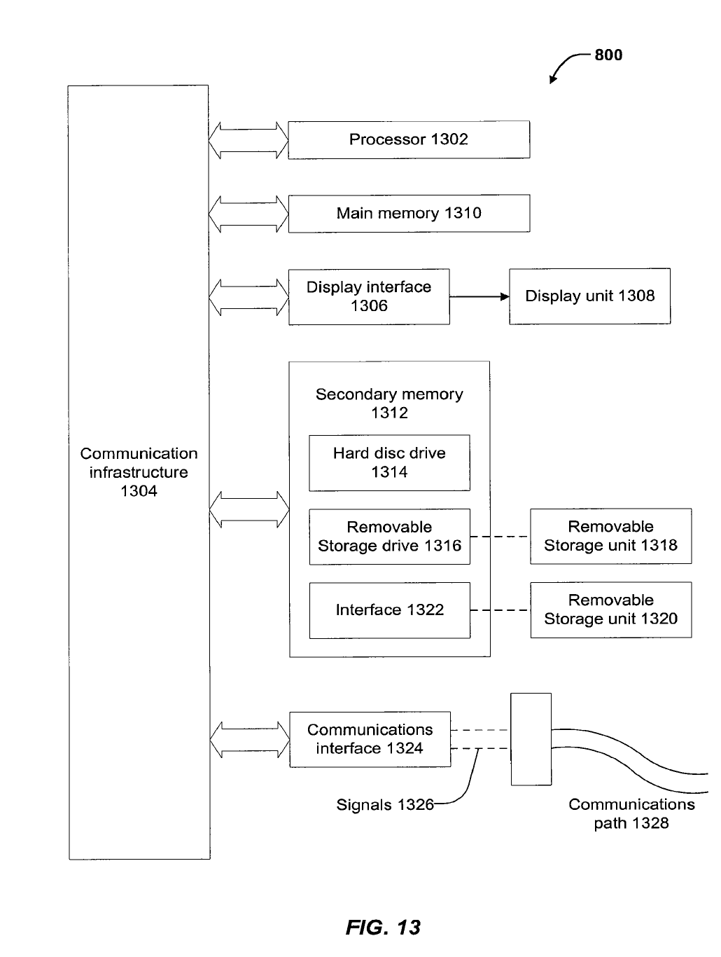

In fact, in accordance with an embodiment of the present invention, the present invention is directed towards one or more computer systems capable of carrying out the functionalities of various embodiments already described above. An example of the computer systems includes a computer system 1300, which is shown in FIG. 13.

The computer system 1300 includes at least one processor, such as a processor 1302. Processor 1302 is connected to a communication infrastructure 1304, for example, a communications bus, a cross over bar, a network, and the like. Various software embodiments are described in terms of this exemplary computer system 1300. After reading this description, it will become apparent to a person skilled in the relevant art(s) how to implement the present invention using other computer systems and/or architectures.

The computer system 1300 includes a display interface 1306 that forwards graphics, text, and other data from the communication infrastructure 1304 (or from a frame buffer which is not shown in FIG. 13) for display on a display unit 1308.

The computer system 1300 further includes a main memory 1310, such as random access memory (RAM), and may also include a secondary memory 1312. The secondary memory 1312 may further include, for example, a hard disk drive 1314 and/or a removable storage drive 1316, representing a floppy disk drive, a magnetic tape drive, an optical disk drive, etc. The removable storage drive 1316 reads from and/or writes to a removable storage unit 1318 in a well known manner. The removable storage unit 1318 may represent a floppy disk, magnetic tape or an optical disk, and may be read by and written to by the removable storage drive 1316. As will be appreciated, the removable storage unit 818 includes a computer usable storage medium having stored therein, computer software and/or data.

In accordance with various embodiments of the present invention, the secondary memory 1312 may include other similar devices for allowing computer programs or other instructions to be loaded into the computer system 1300. Such devices may include, for example, a removable storage unit 1320, and an interface 1322. Examples of such may include a program cartridge and cartridge interface (such as that found in video game devices), a removable memory chip (such as an erasable programmable read only memory (EPROM), or programmable read only memory (PROM)) and associated socket, and other removable storage units 1320 and interfaces 1322, which allow software and data to be transferred from the removable storage unit 1320 to the computer system 1300.

The computer system 1300 may further include a communication interface 1324. The communication interface 1324 allows software and data to be transferred between the computer system 1300 and external devices. Examples of the communication interface 1324 include, but may not be limited to a modem, a network interface (such as an Ethernet card), a communications port, a Personal Computer Memory Card International Association (PCMCIA) slot and card, and the like. Software and data transferred via the communication interface 1324 are in the form of a plurality of signals, hereinafter referred to as signals 1326, which may be electronic, electromagnetic, optical or other signals capable of being received by the communication interface 1324. The signals 1326 are provided to the communication interface 1324 via a communication path (e.g., channel) 1328. The communication path 1328 carries the signals 1326 and may be implemented using wire or cable, fiber optics, a telephone line, a cellular link, a radio frequency (RF) link and other communication channels. Communication path 1328 passes communications such as for example between system 102 and merchant 104, between system 102 and visitor device 106, between system 102 and marketing affiliate 202, between system 102 and site content manager 502, and between system 102 and paid search bid manager 402, etc.

In this document, the terms “computer program medium” and “computer usable medium” are used to generally refer to media such as the removable storage drive 1316, a hard disk installed in hard disk drive 1314, the signals 1326, and the like. These computer program products provide software to the computer system 1300. The present invention is directed to such computer program products.

Computer programs (also referred to as computer control logic) are stored in the main memory 1310 and/or the secondary memory 1312. Computer programs may also be received via the communication interface 1304. Such computer programs, when executed, enable the computer system 1300 to perform the features of the present invention, as discussed herein. In particular, the computer programs, when executed, enable the processor 1302 to perform the features of the present invention. Accordingly, such computer programs represent controllers of the computer system 1300.

In accordance with an embodiment of the invention, where the invention is implemented using a software, the software may be stored in a computer program product and loaded into the computer system 1300 using the removable storage drive 1316, the hard disk drive 1314 or the communication interface 1324. The control logic (software), when executed by the processor 1302, causes the processor 1302 to perform the functions of the present invention as described herein.

In another embodiment, the present invention is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present invention is implemented using a combination of both the hardware and the software.

### CONCLUSION

It is to be appreciated that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

The invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Various embodiments of the present invention have been described above. It should be understood that they have been presented by way of example only, and not limitation. It will be apparent to persons skilled in the relevant art that various changes in form and detail can be made from those specifically described without departing from the spirit and scope of the invention. Thus, the breadth and scope of the present invention should not be limited by any of the above-described exemplary embodiments, but should be defined only in accordance with the following claims and their equivalents.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the drawings are directed to both principles of the invention and to specific “embodiment” implementations or examples. They highlight functionality and advantages of the present invention, and are presented as examples to help in understanding the invention. The architecture of the present invention is sufficiently flexible and configurable, such that it may be utilized (and navigated) in ways other than that shown in the accompanying figures.

Further, the purpose of the Abstract associated with this patent document is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1-23. (canceled)

24. A method comprising:
receiving, by a computer system from a marketing partner, user information corresponding to a financial history of a user,
the computer system predicting a profitability metric that corresponds to a seller's expected profit for a potential sale to the user of a particular product offered by the seller, wherein the predicting is based on one or more items of the financial history of the user, and
based on information indicating that the user has purchased the particular product from the seller, determining, by the computer system, an incentive value payable to the marketing partner based on the predicted profitability metric.

25. The method of claim 24, wherein the predicting includes projecting a predicted revenue derived from the user for the particular product based on a plurality of purchases from a plurality of merchants indicated as being made by the user in the financial history in a particular previous time period.

26. The method of claim 24, wherein the financial history of the user includes data corresponding to a plurality of purchases made by the user in a particular previous time period using a credit card.

27. The method of claim 25, wherein the predicting includes:
applying a profitability factor to the particular product and the predicted revenue projected over a life expectancy of the particular product.

28. The method of claim 24, wherein the predicting the profitability metric comprises:
identifying one or more other users similar to the user based upon respective user information for the user and the one or more other users; and
predicting the profitability metric for the user with respect to the particular product based on respective profitability metrics predicted for the one or more other users with respect to the particular product.

29. The method of claim 24, wherein the particular product is at least one of a financial product, a financial service, a credit card, a loan, or an insurance product.

30. The method of claim 24, further comprising:
based on the user information, calculating a net cash inflow to the seller, during a predetermined time interval, for a predicted use of the particular product by the user, and
projecting the net cash inflow over a life expectancy of the particular product, wherein the profitability metric is based on the net cash inflow calculated.

31. The method of claim 24, further comprising initiating a transfer of the incentive value to the marketing partner.

32. The method of claim 24, wherein the predicting the profitability metric comprises:
based on income history information included in the financial history, estimating predicted revenue from the user during a predetermined future time period.

33. An article of manufacture including a non-transitory computer readable medium having instructions stored thereon that are executable by a computer system to cause the computer system to perform operations comprising:
receiving financial history information of a user from a particular entity;
based on a plurality of items in the financial history, projecting a predicted revenue from the user for predicted use of a particular financial product;
based on the projecting, calculating a profitability metric that corresponds to an expected profit for a potential sale of the particular financial product to the user,
determining, that the user has purchased the particular financial product from a seller, and
based on the determining, causing the particular entity to receive a payment of an incentive value that is based on the profitability metric.

34. The article of manufacture of claim 33, wherein the operations further comprise:
based on spending history information included in the financial history information, projecting the predicted revenue from the user by applying the future spending to a revenue prediction model.

35. The article of manufacture of claim 33, wherein the projecting includes projecting the predicted revenue over a service term of the particular financial product.

36. The article of manufacture of claim 33, wherein operations further comprise:
receiving information from a seller indicating that the user has purchased the particular product.

37. The article of manufacture of claim 33, wherein the operations further comprise:
based on outstanding account balance information included in the financial history information, conducting a risk analysis of a default risk corresponding to the user, and
calculating the profitability metric based on a result of the risk analysis.

38. The article of manufacture of claim 33, wherein the operations further comprise:
calculating the incentive value, including calculating a first portion that is based on a flat fee and a second portion that is based on a percentage of the profitability metric.

39. The article of manufacture of claim 33, wherein the operations further comprise:
causing a plurality of financial product offers that include an offer for the particular financial product to be displayed to the user, such that an offer corresponding to a highest profitability metric is displayed to the user before remaining ones of the offers.

40. A system comprising:
a processor, and
a memory having instructions stored thereon that are executable by the processor to cause the system to perform operations comprising:
based on financial history information of a user, predicting a profitability metric that corresponds to an expected profit for a potential sale to the user of a particular product offered by a seller, wherein the predicting is based on one or more items indicated by the financial history information;
determining an incentive value payable to a provider of the one or more items indicated by the financial history information based on the predicted profitability metric; and
in response to information indicating the user has purchased the particular product, causing the incentive value to be received by the provider.

41. The system of claim 40, wherein the operations further comprise:
based on an application for credit included in the financial history information, estimating a future income associated with the user during a particular future time period; and
predicting the profitability metric by applying the future income over a life expectancy of the particular product to a profitability equation.

42. The system of claim 40, wherein the operations further comprise:
determining, based on at least one item of the financial history information indicating that an income level of the user meets a threshold level, that the user is qualified to purchase the particular product.

43. The system of claim 40, wherein the one or more items indicated by the financial history information include a risk of default associated with the user.
